(19) United States
(12) Patent Application Publication
(10) Pub. No.: US 2025/0322074 A1
(43) Pub. Date: Oct. 16, 2025

(54) METHOD AND SYSTEM RECOVERY FROM UNEXPECTED MEMORY CORRUPTION ON A SYSTEM ON CHIP

(71) Applicant: Ambiq Micro, Inc., Austin, TX (US)

(72) Inventors: Jayesh Shah, Austin, TX (US); Dan Cermak, Austin, TX (US); Ken Alton, Austin, TX (US)

(21) Appl. No.: 19/179,593

(22) Filed: Apr. 15, 2025

Related U.S. Application Data
(60) Provisional application No. 63/634,281, filed on Apr. 15, 2024.

(51) Int. Cl. G06F 21/57; G06F 11/14; G06F 21/55

(52) U.S. Cl. CPC G06F 21/575; G06F 11/1417; G06F 21/554

(57) ABSTRACT

A memory recovery procedure is disclosed for non-volatile memory such as magneto-resistive random access memory for a system on chip. The non-volatile memory stores operating system related code or data. A corruption detection module determines whether the non-volatile memory has been corrupted. A hard coded memory including a recovery routine is operable to access a recovery image stored on an alternate storage system and load the recovery image to the non-volatile memory.

### PRIORITY

The present disclosure claims priority to and the benefit of U.S. Provisional Ser. No. 63/634,281, filed Apr. 15, 2024. The contents of that application are hereby incorporated by reference in their entirety.

### TECHNICAL FIELD

The present invention relates generally to managing memory on a system on chip. More specifically, methods and systems for detection and recovery from an unexpected corruption of non-volatile memory on a system on chip are disclosed.

### BACKGROUND

Chip based computing systems are becoming more ubiquitous as the demand for smart devices with powerful data capabilities increases. Such chips include integrated processing components, support components, memory, and power that execute specific applications for devices that may be written to perform specific device functions. The chips may thus be programmed via specific applications that run either bare-metal or on an operating system executed by the system on chip. On chip non-volatile memory (NVM) storage is generally used to house the operating software, data, and critical hardware trims. Thus, NVM storage is vital to the ability of a device that incorporates the system on chip such as a sensor or a smart watch to function properly. An unexpected corruption of the NVM storage could result in impaired functionality, or in the worst case a completely inoperable device.

Depending on the underlying technology and the application, on chip non-volatile memory could be susceptible to corruption due to various conditions such as power instabilities, magnetic interference, or some other extreme change in the operational environment.

One example of non-volatile memory for a system on chip is magneto-resistive random access memory (MRAM). MRAM is typically used in system on chip products such as an Apollo510 manufactured by Ambiq for non-volatile instruction and data storage. However, in certain circumstances, exposure to very strong external magnetic interference (e.g., an MRI scanner) can lead to the corruption of MRAM on the device. The magnetic interference can be instantaneous from a strong source or there can be an accumulation of interference from a lower strength source over time. Both sources of interference can lead to corruption of memory. In product applications such as smartwatches and wireless sensors where the opportunity for magnetic shielding is minimal, MRAM may be susceptible to disruption from strong magnets, potentially affecting the operation of the wireless product.

Thus, there is a need for a system on chip that allows detection of memory corruption and recovery from such corruption. There is another need for a recovery system that is installed in boot ROM that can be progressively built upon using the same architecture to enable a full system restore. There is another need for a recovery system that allows access to different sources for a recovery image.

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, a system on chip is disclosed. The system on chip includes a non-volatile memory storing operating system related static content for the system on chip. A corruption detection module determines whether the non-volatile memory has been corrupted. A hard coded memory includes a recovery routine operable to retrieve a recovery image stored on an alternate storage system and load the recovery image to the non-volatile memory.

A further implementation of the example system on chip is where the non-volatile memory is magneto-resistive random access memory. Another implementation is where the example system on chip includes a controller coupled to the non-volatile memory. The recovery routine is a part of a secure boot read only memory (ROM) operable to boot the controller. Another implementation is where the recovery routine includes a first stage executed during execution of the secure boot ROM and a second stage executed during execution of a secure boot loader operable to load an operating system for the controller. Another implementation is where the example system on chip includes a processing routine operable to determine whether a source of corruption is present. The recovery routine is executed when the source of corruption is no longer present. Another implementation is where the example system on chip includes an external device interface. The alternate storage system includes a flash memory or an embedded multimedia card in communication with the external device interface. Another implementation is where the example system on chip includes an interface in communication with an external host processor. The external host processor accesses the alternate storage system through a wireless interface or a wired interface. Another implementation is where the recovery routine is operable to validate the retrieved recovery image. Another implementation is where the recovery image is executed by the controller to retrieve the static contents on a back up storage device for restoration of the non- volatile memory. Another implementation is where a boot routine on the secure boot ROM is resumed after the recovery image is executed by the controller. Another implementation is where the example system on chip includes a one time programmable device storing configuration data for the recovery routine. Another implementation is where the recovery routine retries loading the recovery image for a set number of times. An interval of time between each retry increases. Another implementation is where the recovery routine is operable to report a status of recovery to an external host processor. The status of recovery is stored through a device register on a controller or communicated to an external host processor using a general purpose input/output (GPIO) pin. Another implementation is where the example system on chip includes a controller coupled to the non-volatile memory. The corruption detection module is a part of a secure boot read only memory (ROM) operable to boot the controller. Another implementation is where determining the non- volatile memory has been corrupted includes the secure boot ROM determining a failure to authenticate a secure boot loader. Another implementation is where the corruption detection module includes a routine to authenticate the non-volatile memory. Corruption is detected on failure of the authentication. Another implementation is where the corruption detection module includes a periodic routine to perform an integrity check on the static contents of the non-volatile memory. Corruption is detected on failure of the integrity check. Another implementation is where the example system on chip includes an interface coupled to an external host processor. Determining whether the non-volatile memory has been corrupted includes receiving a signal from the external host processor through the external interface. Another implementation is where the corruption detection module includes a routine to detect corruption upon a hard fault or a watch dog time out. Another implementation is where the example system on chip includes an interface coupled to an external host processor operable to provide an alert when corruption is detected.

Another disclosed example is a method of recovering a non-volatile memory storing static content for operating a system on chip. A recovery image is stored on an alternate storage system. The example method determines whether the non-volatile memory has been corrupted. On determining corruption of the non-volatile memory, a recovery routine is executed to access the recovery image from the alternate storage system and load the recovery image to the non-volatile memory.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure will be better understood from the following description of exemplary embodiments together with reference to the accompanying drawings, in which:

FIG. 1 is a diagram of a system on chip in a device with an internal backup image available for an example memory recovery routine;

FIG. 2 is a block diagram of the example system on chip in FIG. 1;

FIG. 3 is a flow diagram of an example memory recovery routine;

FIG. 4 is a table showing register fields accessed by the example memory recovery routine; and

FIG. 5 is a flow diagram for a process of configuring and writing an example recovery asset for the example memory recovery routine.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements, and limitations that are disclosed, for example, in the Abstract, Summary, and Detailed Description sections, but not explicitly set forth in the claims, should not be incorporated into the claims, singly, or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The present disclosure is directed toward a method and system to allow for detection and recovery of a corrupted memory on a system on chip. This addresses external corruption events such as a magnetic field or power supply disturbances that may corrupt memory on a system on chip. The disclosure includes an architecture to detect corruption of memory. A firmware image may be recovered from a variety of sources including an external non-volatile memory, or an interactive recovery session through an external entity.

To manage the problem of corrupted non-volatile memory (NVM) on a chip, an architecture to enable detection of corruption as well as recovery from a corrupted NVM is disclosed. The example recovery system includes a failsafe minimal boot; a corruption detection module; and a recovery module. The basic recovery of firmware images is implemented in the boot ROM of the system on chip and can be progressively built using the same architecture to enable a full system restore. On detection of corruption of the NVM, the recovery module may retrieve a recovery image stored on an alternate storage device.

In order for any recovery implementation in the boot ROM or in any following software to work, the system on chip needs to be designed for failsafe minimal booting, which is not impacted by the corruption event. This necessitates that any vital boot trims are hardcoded in the ROM, or stored in an alternate medium (e.g., fuses), which is not subject to corruption. The recovery may be initiated by self-detection as part of boot flow, or initiated based on variety of internal or external triggers.

Corruption detection may implemented by multiple mechanisms. For example, detection may be implemented as “boot time detection”, which relies on a (secure) boot flow of the device to check for the integrity of the software. A failure in the integrity of the software is treated as corruption. Another example is an “active surveillance” routine that relies on periodic monitoring and authentication to detect a corruption event. Another example may be to incorporate fault detection to trigger an integrity check on demand to detect a corruption event.

Once corruption is detected, a recovery is initiated by execution of the ROM code as part of the boot process of the system. The recovery includes accessing an alternate storage device that stores a recovery image. Depending on the specifics of the design, the recovery could be automatic, relying on off-chip NVM alternate storage such as a flash device or an eMMC device storing the recovery image, or communication with a host processor to download the recovery image, in the case of a multi-chip design. Once the recovery image is retrieved, an encrypted recovery image is loaded into the static random access memory (SRAM) and the recovery image is decrypted and verified. The verified recovery image is then loaded into the on chip non-volatile memory such as MRAM and the system may then operate from the restored recovery image on the MRAM.

Some deployments of the recovery routine could rely on explicit signaling of a corruption event, which triggers an external recovery through alternate means using wired interfaces like UART, SPI or USB or wireless interfaces such as BLE or Wireless OTA. The recovery flow may also include other optional tasks such as alert notifications to the user (via display message/image, sound/haptic or the like), and/or status notifications that recovery is in progress and/or completed. The example detection and recovery architecture is scalable, allowing recovery to be built in stages to keep the overhead and impact on the boot ROM to minimum, but at the same time allowing progressive reuse in later boot stages.

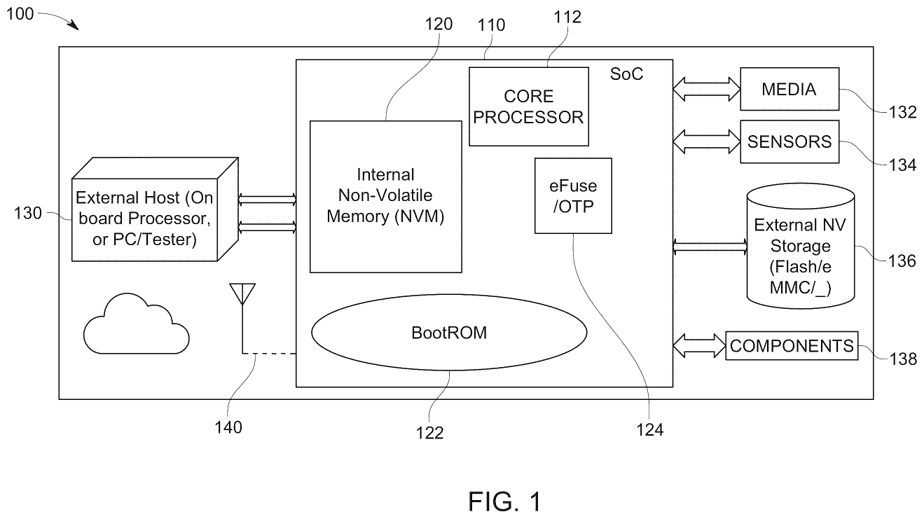

FIG. 1 shows a block diagram of a device 100 with a system on chip 110. The system on chip 110 includes a core processor 112 and non-volatile memory 120 that is a magneto-resistive RAM (MRAM). The system on chip 110 also includes permanent memories such as a read only secure boot read only memory (ROM) 122 and a one time programmable (OTP) device such as an e-fuse 124 that may be read by the core processor 112. In this example, the system on chip 110 is installed in the device 100 and the core processor 112 executes applications generally stored in the non-volatile memory 120 to operate the device 100 to perform different functions.

The device 110 may include an external host processor 130 that controls the functions of the system on chip 110, which may be connected via wired interfaces such as UART, SPI, or I2C interfaces. The system on chip 110 controls and accesses a set of components on the device 100 that may include media devices 132 such as a display or an audio output, sensors 134, a non-volatile (NV) memory device 136 such as MSPI Flash or eMMC, or other components 138. As will be explained the NV memory device 136 serves as an alternate storage device for storing a recovery image. The host processor 122 could be coupled to a wireless interface 140 such as Bluetooth or Wifi that allows communication with external components to the device 100.

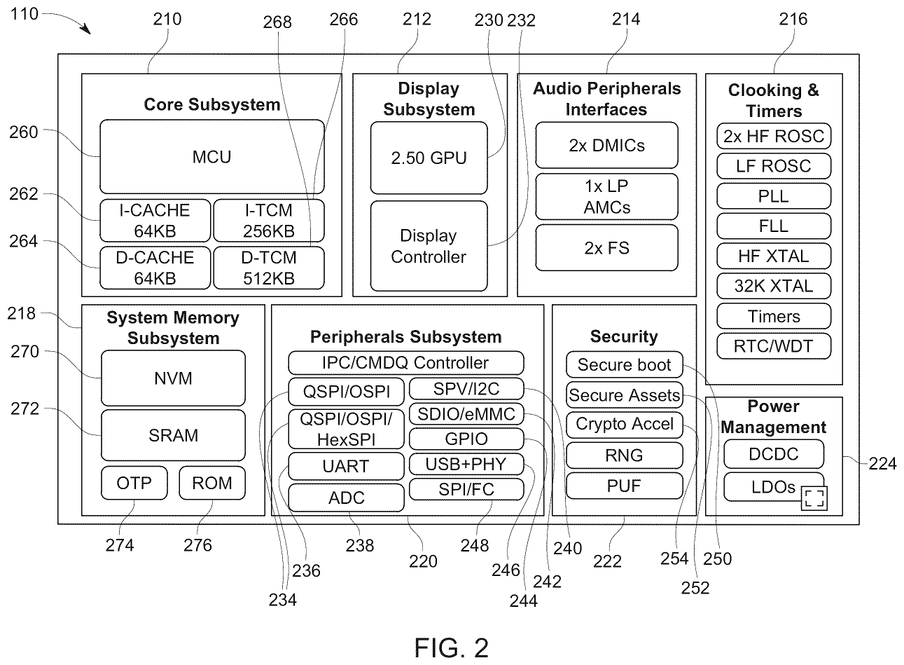

FIG. 2 shows a block diagram of the system on chip 110 in FIG. 1. The system on chip 110 includes a core subsystem 210, a display subsystem 212, an audio peripherals subsystem 214, a clock and timers subsystem 216, a memory subsystem 218, a peripheral subsystem 220, a security subsystem 220, and a power management subsystem 222. The display subsystem 212 includes a graphic processor 230 and a display controller 232 to drive displays on the device. The audio peripherals subsystem 214 includes different audio peripheral interfaces for driving audio components on the device. The clock subsystem 216 includes timers and clocks for the system on chip 110.

The peripheral subsystem 220 includes different interfaces such as QSPI/OSPI/HexSPI interfaces 234, UART interfaces 236, analog to digital converters 238, SP/I2C master interfaces 240, SDIO (Secure Digital Input Output)/MMC (Multi-Media card) interfaces 242, a set of general purpose input/output (GPIO) pins 244, a USB interface 246, and a SPI slave interface 248. The peripheral interfaces are managed by a peripheral controller. The security subsystem 220 includes a secure boot 250, security assets 252, and a crypto accelerator 254. The power management subsystem 222 includes power sources such as low drop out (LDO) and DC power regulator supply sources.

The core subsystem 210 includes a controller 260 such as a microcontroller. In this example, the controller 260 is an ARM Cortex MCU, but any suitable programmable controller or processor may be used. The core subsystem 210 includes an instruction cache 262 and a data cache 264. The core subsystem 210 includes an instruction tightly controlled memory (TCM) 266 and a data TCM 268. The memory subsystem 218 includes non-volatile memory 270, which is MRAM in this example. The subsystem 218 also includes synchronous static random access memory (SSRAM) 272, a one-time programmable (OTP) device 274, and a read only memory (ROM) 276. In this example, the OTP device 274 is an e-fuse.

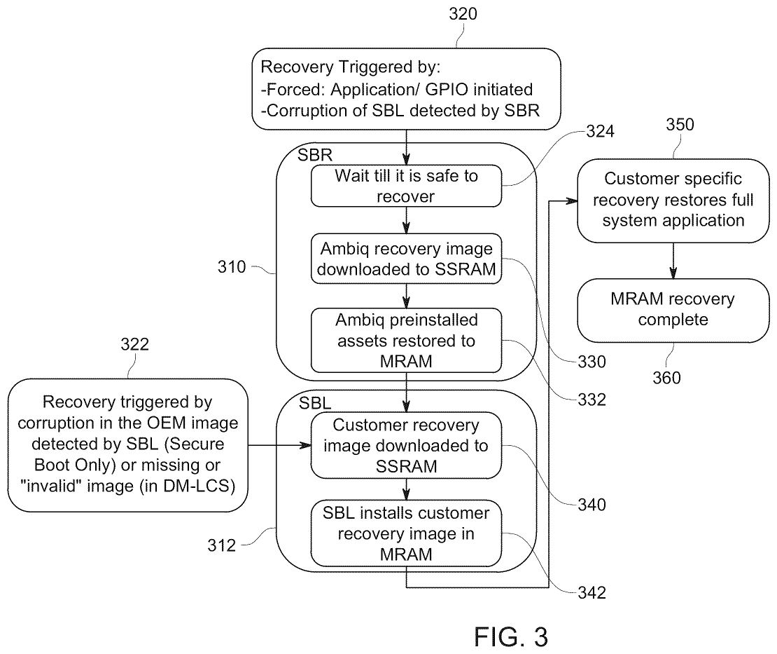

FIG. 3 shows a flow diagram of the process of recovery of a corrupted memory on a system on chip such as the system on chip 110 in a device. The example process operates through code in a secure boot ROM (SBR) 310 in the ROM 276 in FIG. 2 and a secure boot loader 312 such as the secure boot loader 250 in the security subsystem 222 in FIG. 2. A memory recovery may be forced by an application executed by the processor on the system on chip such as the microcontroller 260 in FIG. 2 (320). Alternatively, a trigger signal may be received by a GPIO pin that is initiated from an external processor such as the external processor 130 in FIG. 1, or may be initiated by corruption of the secure boot loader (SBL) firmware detected by the secure boot ROM (SBR) 310 itself (322).

Once a corruption is detected, the secure boot ROM 310 runs a special processing routine to check if the device is under active influence, or if it is safe to initiate recovery (324). Trying to restore the contents by writing the MRAM while still under magnetic influence could be futile, as the write itself may fail, or may be unreliable. This special processing uses a combination of MRAM built-in features, and software based checks. Underlying MRAM supports an autowakeup sequence, following which software can check a reference flag, which is expected to read a fixed pattern under normal case. However, under magnetic influence, an incorrect value may be read. The special processing logic to detect when it is safe to do the recovery, relies on the reference flag check over multiple tries over progressively increasing periods of times to determine whether the device is under active influence. Thereafter as a fool proof check, the processing routine writes a test pattern to MRAM and reads the test pattern back to confirm that the MRAM can be safely written, before proceeding with the next stage of recovery.

The first recovery stage can occur autonomously during the secure boot flow or can be initiated by the background passive or active monitoring performed by an application executed by the host processor such as the microcontroller 260 in FIG. 2, or explicitly triggered by an external processor such as the external processor 130 in FIG. 1. As part of the normal secure boot flow, the SBR 310 must validate the certificate chain used to authenticate the SBL 312. If the authentication operation fails, then MRAM corruption is suspected in either the SBL image or the content certificates of the SBL 312. In this case, the SBR 310 autonomously triggers a recovery of the SBL assets when configured and enabled. Thus, a recovery image may be downloaded to the SSRAM such as the SSRAM 272 in FIG. 2 from an alternate storage device such as the NV memory device 136 in FIG. 1 (330). The recovery image is then restored to the MRAM (332).

If the device is using a non-volatile backup such as a MSPI Flash or an eMMC, then the recovery flow will continue through the next two stages autonomously. If the device is using one of the wired interfaces, the corruption event may be flagged using an optional status GPIO from the system on chip 110 in FIG. 1 to an external host processor such as the host processor 130 in FIG. 1 (322). Subsequently, the system on chip 110 will then wait for the host processor 130 to initiate the recovery stages.

A second stage of the example MRAM recovery process occurs in the secure boot loader (SBL) 312. The second stage of MRAM recovery occurs autonomously during the secure boot flow. A triggering process occurs that includes corruption detected in the SBL (322). Like the SBR 310, the SBL 312 must validate the certificate chain supplied by the customer for their secondary bootloader or application images. Failure of authentication will trigger a recovery of the customer assets similar to the routine in the SBR 310. A user recovery image is downloaded to SSRAM such as the SRAM 272 in FIG. 2 (340). The SBL 312 installs the user recovery image in the MRAM from the SSRAM 272 (342).

The final stage of the example MRAM recovery routine is implemented by the user of the system on chip, based on the design requirements of a product incorporating the system on chip. Once the SBL 312 restores the recovery image provided by the user, the SBL 312 will pass control to this image. The user is responsible for the functionality of the recovery image to recover remaining NVM assets (350). The functionality of the recovery image may build upon the infrastructure for recovering further stages, or could have a completely independent approach to recovery. For example, the recovery image may execute communications to other outside devices via a USB (Universal Serial Bus) or Bluetooth Low Energy FOTA (Firmware Over-the-Air) update services through the appropriate interface to fully recover the MRAM image. The recovery routine is complete once all of the MRAM is restored (360). Integrity/authentication failure may trigger recovery during any stage of the secure boot flow. These stages operate independently and recover only the assets required. For example, the SBR stage may pass verification of the SBL, but the SBL stage could fail to verify the secondary bootloader or main application. In this case, the recovery routine starts only in SBL and installs the user recovery image to restore user assets.

The example recovery routine includes several configurable options for retrieving or loading the recovery images. One option is retrieval of the recovery image through a generic multi-bit SPI (MSPI) driver such as the interface 234 in FIG. 2. This interface uses one of the MSPI modules to attach to an external memory device such as the non-volatile memory device 136 in FIG. 1. In this example, the external non-volatile memory device is a flash memory device that contains the recovery assets. Since there is no uniform interface to all MSPI flash devices, the generic and extensive configuration information allows for adapting to a variety of devices with specific MSPI device settings, as well as the ability to send up to four “pre-commands” to the MSPI device to get it into the proper state before the contents can be accessed.

Another option is an embedded multi-media card (eMMC) device interface such as the interface 242 in FIG. 2. This interface uses one of the SDIO (Secure Digital Input Output) modules to attach to an external memory device such as the non-volatile memory device 136 in FIG. 1. In this example, the external non-volatile memory device is an eMMC device that contains the recovery assets. The protocol to the eMMC device is mostly standardized, so the configuration of the external device is not required.

Another option is a UART or a SPI wired interface from a host processor such as the host processor 112 on the device 100 in FIG. 1. The example system on chip 110 in FIG. 2 supports wired interfaces from the external host processor such as the host processor 130 in FIG. 1 or an external personal computer (PC) via both the SPI interface 234 and the UART interface 236 in FIG. 2. Since the MRAM recovery routine is active in both the SBR 310 and the SBL 312, the wired protocol message responses to the initial connection establishment over the wired interfaces indicates whether SBR 310 or SBL 312 is executing, and which recovery operation is in progress. If both UART and SPI interfaces are enabled, the SBR 310 and or the SBL 312 will look for activity on the UART interface prior to switching to the SPI. Typically, both UART and SPI interfaces are not enabled simultaneously. It is preferable that a user chooses either the UART or SPI interface and configure the MRAM recovery routine for a single wired interface.

The recovery assets for the example recovery routine are uniquely formatted for interpretation by either the SBR 310 or the SBL 312. In this example, a software development kit such as the AmbiqSuite SDK may include tools to generate MRAM recovery asset images.

One example of a recovery image offered by the system on chip manufacturer may contain the secure boot loader and the certificate chain required to authenticate it. This image is primarily provided by a vendor from the affiliated software development kit (SDK).

A user designed specific image contains a specific recovery image to the user and the certificate chain required to authenticate the recovery image. Additional assets as needed by the customer specific recovery application may also be required such as recovery of certain static data, tables or file systems.

For either the MSPI/Flash or SDIO/eMMC NVM options, the configuration data in the OTP contains a single location that specifies the meta data file on the recovery media. The meta data file contains the specific locations (sectors or block) on the device of where the recovery images are stored.

The recovery assets must be maintained on the external non-volatile device 136 or in the host processor 130 in FIG. 1. If the user installs an SBL update, new application images, or monitored data, then the recovery assets must be kept updated to ensure the proper versioning if anti-rollback features are used.

If any of the passive or active monitoring applications detects MRAM corruption, the user may also provide for triggering the MRAM recovery flow through an application API call or through a configurable GPIO on the external host processor. In this case, any applicable method for detecting corruption may be used. For example, a test could be added to the Hard Fault or Watchdog ISR timeout initiated by the operating system of the host processor to trigger recovery through an API call when an abnormal condition is detected. Additional more active measures such as periodic CRC checks on static images or dynamic data may be used in addition to the passive monitoring methods to detect corruption. In some configurations, there could be a periodic handshake between the external host processor and the SoC, that could be used to monitor the health of the SoC, and upon failure, the host processor could initiate recovery through a GPIO.

The recovery status may be output during the process in FIG. 3. Depending upon the particular deployment case, recovery status may be reflected in several ways. An optional GPIO pin can be used by an external host processor that may be used to monitor whether an autonomous recovery in process. A register such as a RSTGEN->STAT register in the controller may include results for the MRAM recovery routine performed by the SBR and SBL during the current boot cycle. The register may include data such as: a) SBL MRAM Recovery Occurred, Success/Fail; b) OEM MRAM Recovery initiated by SBL Occurred, Success/Fail; c) SBL Recovery Image loaded from NV or Wired, and if the MRAM restore was successful; d) OEM Recovery Image loaded from NV or Wired, and if the MRAM restore was successful; e) the reason for MRAM recovery, e.g., SBL Certs, OEM Certs, GPIO, or App Request; f) the source of the wired interface (UART or SPI); and g) MRAM Recovery is in process, which is an internal status and will not be visible to a device application, but could be seen during development with a debugger.

Another mechanism for recovery status may be a field written on a one time programmable device such as the Efuse 124 in FIG. 1 (OTP_INFO1_MRAM_RCVY_CNT0/1) A non-volatile count is maintained (in the INFO1-OTP register on the core processor on the system on chip for example) of how many times MRAM recovery has been successful. These words are bit-counts where each bit set represents a successful recovery. In this example, the count saturates at 63 (2 words), readable always by the user application. In addition, both the example SBL and the OEM recovery applications output the count in the serial wire output (SWO) logs. The example OEM recovery application also keeps a count of successful OEM recovery operations in a similar fashion, in INFO0-OTP, and outputs the same in the SWO logs.

In some cases, an initial recovery attempt may not succeed due to ongoing intermittent exposure to magnetic interference. The example MRAM recovery routine provides an option to retry the recovery a specific number of times over increasing time intervals. The first retry attempt is tried after a minimum time interval. The interval is increased by the minimum interval; thus, the second attempt will be after another 2x (minimum time interval). This continues until the interval reaches the maximum interval. All remaining retries will use the maximum interval until the maximum number of retries is reached. A power cycle of the device will restart the MRAM recovery process and restart the retry count and times.

For external storage devices such as a MSPI Flash or an eMMC there is a specific power-up and reset sequence to set up the device in a good state to retrieve the recovery assets for the example recovery routine. A number of configuration options are provided that could be tuned for specific device usage. First, the external device could be optionally powered on via a specified pin and polarity. After power on, a configurable delay is executed. The delay may be configured via a 12-bit field and is specified as μs or ms. The external storage device is then optionally reset via a specified reset pin and polarity specified. The reset is followed by a device reset delay time that may be configured via a 12-bit field and is specified as us or ms. A JEDEC reset for the MSPI device is performed, if enabled. The JDEC reset is followed by a device reset delay for the same time. If configured, a set of Pre commands are sent to the MSPI flash device. Pre commands can be used to put external MSPI flash devices into specific data transfer mode corresponding to the recovery configuration in the INFO0 field stored in the OTP, but their use is very device dependent.

The external storage device is then ready to be read for the recovery images that may be written into SRAM. The recovery images will be authenticated and loaded into the MRAM. After the recovery assets are read from the external storage device, the external storage device is reset and powered down in the opposite order. All pins are then returned to their reset state.

In the initial system on chip, the INFO0 field is unprogrammed. The devices are provided in Device Manufacturing Life Cycle Stat (DM LCS). The default behavior for the example MRAM recovery routine must be programmed by the user into the INFO0 and INFOC fields in the OTP during the production and manufacturing process of the device incorporating the system on chip.

The INFO0 field should be programmed coincident with the MRAM Recovery assets. To facilitate development trials, the design supports configuration options & trims in both MRAM and OTP versions of INFO. As with all development, the production programming process should initially be developed using the MRAM based trims, and tested using means other than real magnet induced corruption, then transitioned to the OTP based trims once the final configuration is settled, prior to field deployment.

The example MRAM recovery process should be considered during the product design phases, depending upon the application of the system on chip and external device considerations. Specifically, such considerations include location of the recovery assets (an NVM or an external host processor), selection and configuration of the MSPI or SDIO instance to use for the example MRAM recovery routine, power and reset pin selection for an external device, GPIO Control and Status pins, polarity, pullup/pulldown requirements, Powerup/reset delay requirements for the selected external device, and the MSPI sector/page and eMMC partition selection/management for recovery assets enabling MRAM recovery. Many MSPI Flash devices include non-volatile configuration registers which may be programmed by user to suite their application. The example MRAM recovery routine is designed to avoid changing these non-volatile registers.

In this example, the MRAM recovery is configured and enabled in the INFO0 configuration field of the controller on the system on chip. The fields are defined in detail in the register definitions included with the SDK. There are five main configuration fields for the example MRAM recovery routine in the configuration field for enables, metadata location, resets, alternate storage device specific configuration, and retry configuration. The enable words include whether the MRAM Recovery feature itself is enabled, and whether specific options like the application initiated MRAM Recovery and the GPIO initiated MRAM recovery is enabled. It also controls whether a GPIO based MRAM recovery status output is enabled.

The source of recovery data word includes a designation of the external device or interface of MSPI-Flash, eMMC, Wired-UART, Wired-SPI and the instance number for MSPI or eMMC to use. The metadata location word specifies the location of the page (MSPI) or block (eMMC) that contains the metadata that describes the location and sizes of the recovery images. A set of configuration options to allow to talk to a variety of external non-volatile storage, MSPI flash or eMMC are provided to be able to talk to a variety of different devices. The Retry Configuration customizes how the recovery attempts are retried in the event of continuous magnetic interference.

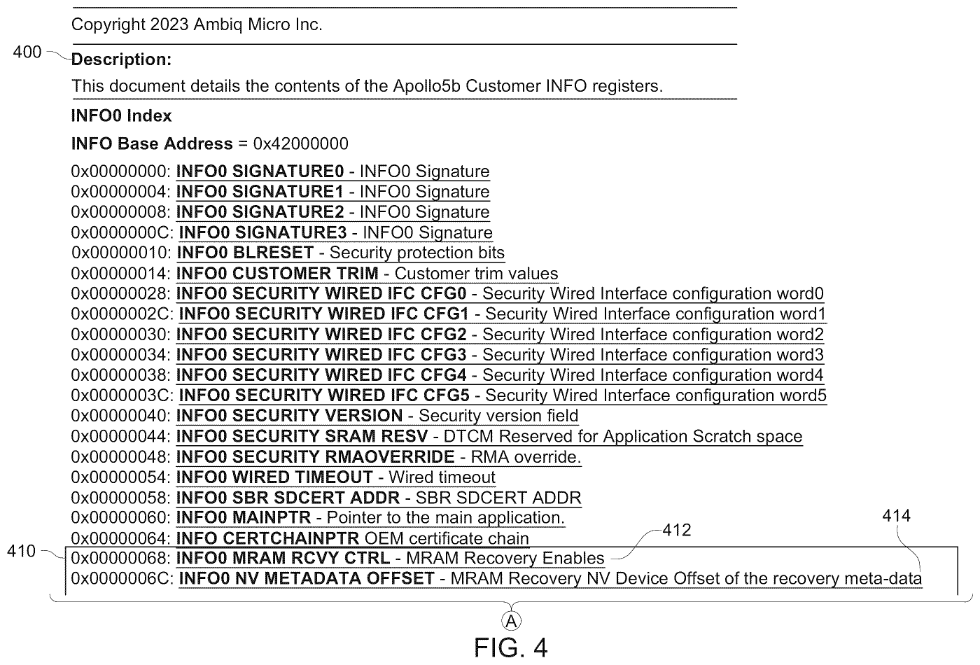

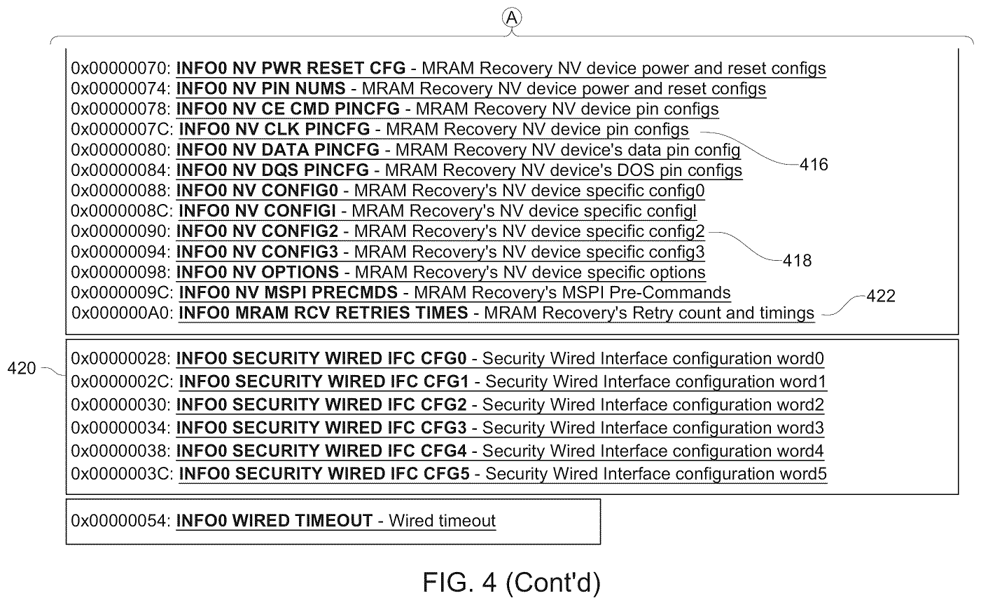

FIG. 4 shows an example table 400 of the fields in the INFO0 register and specific locations for the recovery configuration settings for the example MRAM recovery process. The configuration data (INFO0) written in the OTP includes general information for the host processor such as identification data, trim values, OEM certificates, and security. A recovery data section 410 includes data for the example memory recovery routine for the system on chip. The recovery word section includes a recovery enables field 412 that is one word that includes a Master Enable (for MRAM recovery to be enabled INFO0 must be valid, and master enable set); a GPIO Pin for Recover in Progress indication (0xFF means unused); a NV type and module number (EMMC, MSPI or none); a Wired Enable and type (for UART or SPI, additional configs are specified in the existing INFOC WIRED_CONFIG fields), an application initiated Recovery enable; a GPIO initiated Recovery enable (Pin #and Polarity); and an application initiated fail option (Reboot or spin if App initiated recovery fails).

The section 410 also includes a one word Metadata Offset field 414. The Metadata offset is a pointer in the external non-volatile memory to a set of records that define location and size of the recovery images. In this example, an SOC vendor provided recovery routine defines and uses the first two records where the first record specifies the SBL recovery image and the second record is the OEM recovery image. Additional records for user created recovery images are user defined. Each record is two words and defines the offset and size of a recovery image

The section 410 also includes a set of NV device configurations 416 in a set of NV device configuration fields for the NV device that stores the recovery images. These include power, reset, pin numbers and configurations (Power/Reset/Pin #& configs). During device access, the NV device will be powered on via specified pin and polarity (if enabled), which is followed by configurable delay (12-bit field, specified as μs or ms). Next, the device will be reset via a reset pin with specified polarity with a 10 us pulse (if enabled) which is followed by a device reset delay time (12-bit field, specified as μs or ms). Finally, in this example, an optional JEDEC reset for MSPI (if enabled) will be executed, which is followed by device reset delay (same value as reset delay field above).

The NV device can then be read, and the recovery image loaded into SSRAM as explained above. After reading the NV device (successful or not) the NV device will be reset and powered down in the opposite order. All pins will be de-configured and returned to their reset state following the loading process.

The Power and Reset options thus include one word that defines Power pin polarity; Reset pin polarity; Delay following power-on (12-bit field, specified as us or ms); Delay time following reset (12-bit field, specified as μs or ms); and JEDEC reset for MSPI.

The Pin Numbers are defined in one word. The word includes power and reset pin numbers (0xFF disables the function); and a chip enable (CE) Pin number (for MSPI). All other pin numbers are determined by the NV type and module number.

Different pin configurations are stored in four words. A clock pin (CLK) configuration is specified, where the pin #is determined by the NV type and module number. A CE/CMD pin configuration is used to configure either the CE for MSPI, or CMD pin for eMMC, depending on the specific configuration. Another field defines the configuration of the data pins (Data0-7) where the pin #s are determined by the NV type and module number. A DQS field is for MSPI only defining the configuration for DQS function for MSPI flash devices. The pin #is determined by the module number.

A device specific configuration is provided for an eMMC device. The MRAM_RCVY_CTRL word has a field for defining the eMMC (EMMC_PARTITION) that could be set to User, Boot1, or Boot2 partition. The eMMC devices use only the NV_CONFIG0 and NV_CONFIG1 words. The NV_CONFIG0 word specifies the target speed in Hz. The eMMC device will be configured to closest speed, not to exceed the target. The NV_CONFIG1 word specifies the eMMC UHS mode. The NV_OPTIONS word has 2 fields related to eMMC. The EMMC_BUS_WIDTH field allows for setting 1, 4, or 8-bit SDR/DDR. An EMMC_VOLTAGE field allows for setting 1.8V, 3.0V, or 3.3V.

For MSPI, the MRAM_RCVY_CTRL includes the MSPI module number to use (0 to 3). A device specific configuration field 418 is provided for an MSPI flash device. The field includes NV_CONFIG0-4 words and fields in NV_OPTIONS word and MSPI_PRECMDS used by MSPI devices. A NV_CONFIG0 word is written directly to the DEV0CFG register of the specified module. A NV_CONFIG1 word is written directly to the DEV0CFG1 register of the specified module. A NV_CONFIG2 word is written directly to the DEV0DDR register of the specified module. A NV_CONFIG3 word is written directly to the DEV0SCRAMBLING register of the specified module.

A NV_OPTIONS Word—MSPI has 5 fields. A READCMD field is an 8-bit read command sent when reading the metadata and recovery images. A PRECMD_CTRL field includes data that indicates how to send pre-commands, if any, before reading images. A PRECMD_CLKSEL field includes setting CLKSEL when sending pre-commands. A WIDTHS field defines the width of the read transfers (loaded into the MSPIx_CTRL1 register PIOMIXED field). A READ_CLKSEL field includes the CLSEL register setting used when reading the metadata and recovery images

A NV_MSPI_PRECMDS defines one word of 4 bytes that can be sent before reading the Metadata/recovery images. This allows sending various combinations of CMDs or CMD with 1 or 2 data bytes.

Another set of fields 420 includes data for MRAM wired recovery configuration. The wired recovery uses the wired configurations in the INFOC and INFO0 registers. A wired configuration field WIRED_CONFIG in the INFOC selects the UART and/or SPI, and in case of UART specifies which UART module. MRAM Recovery uses IO Slave (IOS) and WIRED_CONFIG also identifies a SLAVEINT pin used for handshake with external host. WIRED_CONFIG also has fields to allow for I2C to be used as an option for wired interface in future. A configuration field in INFO0 (WIRED_IFCx (0-5)) and WIRED_TIMEOUT configure UART parameters. In this example, both the UART and SPI use a recovery message exchange when interacting with either the BootROM or the SBL. The messaging protocol to use over UART/SPI is reused from existing wired protocol in use by SBL for wired updates. In this example the HELLO Status response message is used to distinguish between a vendor (e.g., Ambiq) and an OEM recovery initiated by the SBR and SBL respectively. If both UART and SPI are enabled, the UART will be tried first and then the SPI will be tried.

If the MRAM recovery fails for any reason, it will retry a configurable number of times. As explained above, depending on the length and intermittent nature of magnetic interference, recovery may not succeed the first time. A retry field 422 (MRAM_RCV_RETRIES_TIMES) has 3 fields to allow for retry configurations. These include MAX_RETRIES, which is the maximum number of retries (16-bit, 64K max retries), MIN_RETRY_TIME, which is the initial time between retries (in seconds), and MAX_RETRY_TIME, which is the maximum time between retires (in Minutes). The time between retries will start with the time specified in MIN_RETRY_TIME (in seconds) and will increment by that same value up to, but will not exceed the MAX_RETRY_TIME (in Minutes). If the maximum retries are exceeded, the device will be “locked” and will require a power cycle. Power cycling the device will reinitiate the recovery process, and retry the full recovery number or retries and times. In this example, if MRAM recovery was initiated by the application or via a GPIO, and there was no real MRAM corruption, and the recovery fails all retries for any reason (e.g. the recovery images are not loaded into NV memory), the subsequent reset will boot normally.

In this example, the example recovery options may be configured using tools in a software development kit (SDK). A recovery image binary may be created using a non-secure boot routine in the DM-LCS. At this stage no OEM certificates are required, thus the SBL cannot detect corruption of the OEM image. However, the other detection methods are operational. This allows a user to test the NV device provisioning and INFO0 settings with a quick path to recovery if something goes wrong, using MRAM INFO0.

A user may create an OEM recovery application specific to how the product using the system on chip maintains access to program images/data and how the user plans to use the MRAM. Simplified example OEM recovery applications may be included in an SDK that can be used as the basis for their custom application.

An example SDK allows a user to determine where on the NV device the SBL, OEM Recovery Image(s), and Metadata will be located. The SDK includes an example (see/examples/mram_recovery/image_loader) which could be modified to match the customer's product pin selections and NV device. For example, Ambiq's Recovery Image (SBL & Certificates) are also supplied in the SDK available from Ambiq. Once the image_loader program has been updated and compiled, the user may update the recovery_loader.ini file to load the images into the NV device.

The next step is to determine the configuration settings and desired options in INFO0 fields. Once this has been done, a one step create tool (e.g., create_info0.py) may be used to create the INFO0 binary that can be used for programming either the MRAM or OPT INFO0 spaces. At this stage, the INFO0-MRAM may be used to verify and test the configuration and NV device, however, actual magnetic interference testing requires INFO0 to be configured in OTP as the active configuration.

Once the NV storage device and INFO0-MRAM configurations are established, the user may test the MRAM Recovery flow using an application-level call or using GPIO initiated recovery. The final steps for testing the example MRAM recovery routine include creating the OEM Certificates, rebuilding the OEM Recovery Image, and using the recovery loader to program the NV storage device. In this example, the INFO0-OTP may be programmed with the same settings confirmed in the MRAM-INFO0. The user secure boot (CUST_SECBOOT) may be switched to secure boot enabled (SBEN). The device may be switched to boot from the OTP device 124 in FIG. 1 via a selection (OTP_INFOC_SHOW_TRIM_INFO0_SEL) in OTP INFOC. At this point, the system is enabled for actual magnetic interference testing.

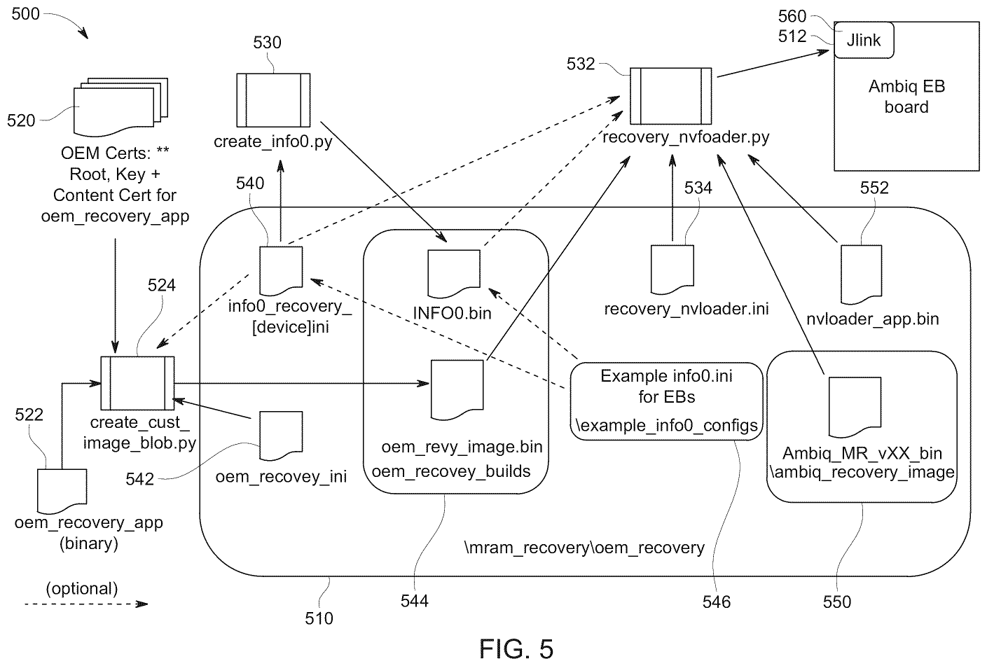

FIG. 5 shows the overall MRAM recovery tool flow 500 provided by the system on chip manufacturer. The tool flow 500 in FIG. 5 allows the preparation of a recovery process 510 that can be loaded on an evaluation or engineering board 512. The recovery process 510 includes OEM certifications 520 for the recovery and a binary of a recovery application (oem_recovery_app) 522 that are combined to create a custom image creation script 524 (create_cust_image_blob).

The recovery tool flow allows the generation of various configurations and assets. A script create info0 file 530 is used to create a unified INFO0 image combining all the configuration options, including the MRAM recovery settings specified in an information recovery device (info0_recovery_[device].ini) file 540. The image creation script file 524 is used to create an OEM recovery image 544 using the user supplied recovery application 522, related certificates 520 and a configuration information file (oem_recovery.ini) 542. A base configuration (info.ini) 546 is used as a basis for created the information recovery device file 540. A script recovery loader (script recovery_nvloader) 532 is used to combine all the recovery assets (a vendor recovery image 550 and OEM recovery image 544) and a programming information files (recovery_nvloader.ini) 534 along with a memory loader file (nvloader_app.bin) 552 to create a unified image, which when programmed on the evaluation board or engineering board 512 (using a Jlink 560) and run on the SoC 110 in FIG. 1, will program the NV storage device such as the storage device 136 in FIG. 1) with all the recovery assets including the metadata.

In this example, there are several fields that need to be consistent between the various scripts with what is programmed in INFO0 space. These include a main pointer to the main image (MAINPTR), a pointer to the certificate chain (CERTCHAINPTR) used to validate the image, a metadata offset that signifies the location in the external flash that contains the recovery assets, (NV_METADATA_OFFSET_META_OFFSET), a recovery control type that specifies whether the external memory non-volatile is an MSPI flash or eMMC, (MRAM_RCVY_CTRL_NV_RCVY_TYPE), a module number for the interface (MSPI or SDIO) connected to external NV device, (MRAM_RCVY_CTRL_NV_MODULE_NUM), and a partition number for an eMMC (MRAM_RCVY_CTRL_EMMC_PARTITION), if configured for eMMC.

In this example, there are several fields that need to be consistent between various scripts that generate the recovery assets, with what is programmed in INFO0 space. These include a main pointer to the main image (MAINPTR), a pointer to the certificate chain (CERTCHAINPTR) used to validate the image, a metadata offset that signifies the location in the external flash that contains the recovery assets, (NV_METADATA_OFFSET_META_OFFSET), a recovery control type that specifies whether the external non-volatile memory is an MSPI flash or eMMC, (MRAM_RCVY_CTRL_NV_RCVY_TYPE), a module number for the interface (MSPI or SDIO) connected to external NV device, (MRAM_RCVY_CTRL_NV_MODULE_NUM), and a partition number for an eMMC (MRAM_RCVY_CTRL_EMMC_PARTITION), if configured for eMMC.

Each of the scripts has an optional keyword (info0_cfg) with the path to the corresponding INFO0 configuration (info0.ini config) to be used. If supplied, the fields above are checked for consistency if specified in both.ini files. Alternatively, the fields can be left out in each script and the values from the info0.ini will be used instead. Any inconsistencies will be flagged as an error while the scripts are running. All scripts will have the same defaults for fields not specified. If the keyword (info0_cfg) is not specified, the scripts will work separately (standalone) and no consistency checks are done. The SDK examples use the keyword (info0_cfg) so inconsistencies will be flagged if changes are made.

Optionally, the recovery script 532 file (recovery_nvloader.py) can also generate and load INFO0 if the info0_cfg path is supplied, however, INFO0 can always be loaded separately using an independent script (such as the jlink-prog-info0.txt or jlink-prog-info0_otp.txt) in the example Ambiq SDK.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations, and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

Each of these embodiments and obvious variations thereof is contemplated as falling within the spirit and scope of the claimed invention, which is set forth in the following claims.

What is claimed is:

1. A system on chip, comprising:
a non-volatile memory storing operating system related static content for the system on chip;
a corruption detection module determining whether the non-volatile memory has been corrupted; and
a hard coded memory including a recovery routine operable to retrieve a recovery image stored on an alternate storage system and load the recovery image to the non-volatile memory.

2. The system of claim 1, wherein the non-volatile memory is magneto-resistive random access memory.

3. The system of claim 1, further comprising a controller coupled to the non-volatile memory, and wherein the recovery routine is a part of a secure boot read only memory (ROM) operable to boot the controller.

4. The system of claim 3, wherein the recovery routine includes a first stage executed during execution of the secure boot ROM and a second stage executed during execution of a secure boot loader operable to load an operating system for the controller.

5. The system of claim 1, further comprising a processing routine operable to determine whether a source of corruption is present, and wherein the recovery routine is executed when the source of corruption is no longer present.

6. The system of claim 1, further comprising an external device interface, and wherein the alternate storage system includes a flash memory or an embedded multimedia card in communication with the external device interface.

7. The system of claim 1, further comprising an interface in communication with an external host processor, wherein the external host processor accesses the alternate storage system through a wireless interface or a wired interface.

8. The system of claim 1, wherein the recovery routine is operable to validate the retrieved recovery image.

9. The system of claim 3, wherein the recovery image is executed by the controller to retrieve the static contents on a back up storage device for restoration of the non-volatile memory.

10. The system of claim 9, wherein a boot routine on the secure boot ROM is resumed after the recovery image is executed by the controller.

11. The system of claim 9, further comprising a one time programmable device storing configuration data for the recovery routine.

12. The system of claim 1, wherein the recovery routine retries loading the recovery image for a set number of times, wherein an interval of time between each retry increases.

13. The system of claim 1, wherein the recovery routine is operable to report a status of recovery to an external host processor and wherein the status of recovery is stored through a device register on a controller or communicated to an external host processor using a general purpose input/output (GPIO) pin.

14. The system of claim 1, further comprising a controller coupled to the non-volatile memory, and wherein the corruption detection module is a part of a secure boot read only memory (ROM) operable to boot the controller.

15. The system of claim 14, wherein determining the non-volatile memory has been corrupted includes the secure boot ROM determining a failure to authenticate a secure boot loader.

16. The system of claim 1, wherein the corruption detection module includes a routine to authenticate the non-volatile memory, and wherein corruption is detected on failure of the authentication.

17. The system of claim 1, wherein the corruption detection module includes a periodic routine to perform an integrity check on the static contents of the non-volatile memory, and wherein corruption is detected on failure of the integrity check.

18. The system of claim 1, further comprising an interface coupled to an external host processor, wherein determining whether the non-volatile memory has been corrupted includes receiving a signal from the external host processor through the external interface.

19. The system of claim 1, wherein the corruption detection module includes a routine to detect corruption upon a hard fault or a watch dog time out.

20. The system of claim 1, further comprising an interface coupled to an external host processor operable to provide an alert when corruption is detected.

21. A method of recovering a non-volatile memory storing static content for operating a system on chip, the method comprising:
storing a recovery image stored on an alternate storage system;
determining whether the non-volatile memory has been corrupted; and
on determining corruption of the non-volatile memory, executing a recovery routine to access the recovery image from the alternate storage system and load the recovery image to the non-volatile memory.
